(19) United States
(12) Patent Application Publication
(10) Pub. No.: US 2008/0178883 A1
(43) Pub. Date: Jul. 31, 2008

(54) Gas reclaim regulating valve assembly

(76) Inventor: Leszek Stanislaw Gorski, Richmond, TX (US)

Correspondence Address: Annilee Reed;Suite 3600, 1415 Louisiana, Houston, TX, 77002, US

(21) Appl. No.: 11/657,738

(22) Filed: Jan. 25, 2007

(51) Int. Cl. B63C 11/20; B63C 11/18; G05D 16/06

(52) U.S. Cl. 128/205.24; 137/613; 137/614

(57) ABSTRACT

A gas reclaim regulating valve assembly is described as comprising two chambers by which a diver's exhaled gases can be captured and sent to a gas recovery unit above the water surface. The gas reclaim regulating valve connects to an inlet tube from which the diver's exhaled gas travels from a switchblock. The switchblock attaches to the diver's helmet by way of a switchblock mounting plate. On the opposite end of the switchblock from the mounting plate is a moveable handle by which the circuit to the gas reclaim regulating valve may be opened or closed using one hand. When the circuit is closed, the exhaled gases travel through the inlet tube to the gas reclaim regulating valve wherein it flows through two chambers and out to the gas recovery unit. When the circuit is open, the exhaled gases are expelled out of the system via a one-way valve.

### CROSS-REFERENCE TO RELATED APPLICATIONS

None

### BACKGROUND OF THE INVENTION

This invention relates to a gas pressure regulating valve for use in conjunction with a diving helmet and an underwater breathing apparatus.

Where the breathable gases supplied to a diver include a reclaimable gas such as helium, the exhaled gases are piped to a surface apparatus for extraction of the reclaimable gas in a line at a lower pressure than the diver's gas exhalation pressure. A valve usually termed a “gas reclaim” or “gas recovery” valve is used to isolate the diver's breathing space from the lower pressure in the gas reclaim line.

One previously proposed gas reclaim valve is a single stage device having the disadvantage that the diver's exhalation effort to operate the valve varies according to the pressure differential with the reclaim line. This disadvantage gives rise to discomfort in breathing; and moreover such a single stage device offers little safeguard against the diver being subjected to reclaim line pressure or suction in the event of a malfunction.

Another previously proposed gas reclaim valve is a two-stage valve, but having the disadvantages of, first, being of unduly large physical dimensions and, second, having a relatively large number of moving components whose total mass is such as to demand undue breathing effort to operate the valve. Moreover, this valve is prone to malfunction in the event of ingress of foreign matter, particles, hair, etc.

Yet another previously proposed gas reclaim regulating valve has the disadvantages of an additional cavity through which the diver's exhalation effort must pass. The additional cavity is an area through which gas flows if the circuit is open. However, when the circuit is closed, the cavity is dead-ended and the gas still flows into the cavity as it flows through the system. The additional cavity disturbs the gas as it passes through the system thus demanding undue breathing effort to operate the regulator, also know as work of breathing (WOB). Additionally, in the event of a malfunction, two hands are needed to turn off the valve to alleviate suction from the reclaim line pressure: one to open the circuit and one to turn off the vacuum from the reclaim line. Moreover, this valve may not be disassembled in a way as to provide for easy maintenance.

The object of the present invention is to provide a gas reclaim regulating valve assembly for use in conjunction with a diving helmet and underwater breathing apparatus in which the aforesaid disadvantages are obviated or mitigated.

A high WOB will lead to discomfort and fatigue for the diver and may provide insufficient gas flow during heavy breathing from exertion or the like. A large part of the WOB of any breathing gas recirculation system is associated with the energy absorbed by changes in gas flow through hoses, valves, and other associated parts of the breathing apparatus. Changes in both flow rate and flow direction increase the WOB. As the diver breathes in and out, the changes in gas flow cause pressure to oscillate within the system. The present invention seeks to minimize the impact of the pressure changes by providing improved breathing gas flow to and from the diver by eliminating the cavity used in a previous gas reclaim regulating valve.

Additionally, the present invention seeks to increase safety by allowing the gas reclaim regulating valve to be turned off by way of only one hand instead of two in the case of malfunction or emergency, because opening the circuit and closing the reclaim line can be accomplished with one motion by one hand. The present invention can also be detached from the diving helmet at a switchblock mounting plate with little effort. It can also be disassembled easily for maintenance.

### BRIEF SUMMARY OF THE INVENTION

According to the present invention, there is provided a gas reclaim regulating valve assembly for use in conjunction with a diving helmet and underwater breathing apparatus, comprising a first chamber disposed between a first diaphragm and a separator wall for receiving the exhaled gases, a second chamber disposed between a second diaphragm on the opposite side of the separator wall. A funnel-shaped slotted seat creates a cylindrical-shaped tube between the first diaphragm and the second diaphragm to allow for gaseous communication between the first chamber and the second chamber. The first diaphragm cooperates with the portion of the slotted seat with the smallest diameter to constitute a first-stage valve. The second diaphragm cooperates with the portion of the slotted seat with the largest diameter to constitute a second-stage valve.

The gas reclaim regulating valve connects to an inlet tube from which the diver's exhaled gas travels from a switchblock. The switchblock comprises a first end and a second end. The first end of the switchblock attaches to the diver's helmet by way of a switchblock mounting plate. The second end of the switchblock comprises a moveable handle by which the circuit to the gas reclaim regulating valve may be opened or closed. When the handle has been used to open the circuit to the gas reclaim regulating valve, the diver's exhaled gases do not travel through the inlet tube to the gas reclaim regulating valve. Instead a one-way valve is activated allowing the diver's exhaled gases to be expelled from the switchblock out of the system and into the ambient water without allowing water into the switchblock. When the handle has been used to close the circuit to the gas reclaim regulating valve, the diver's exhaled gases travel through the inlet tube to the gas reclaim regulating valve.

### BRIEF DESCRIPTION OF THE SEVERAL VIEWS OF THE DRAWINGS

An embodiment of the present invention will be described, by way of example, with reference to the following drawings in which:

FIG. 1 is a sectional elevation of a gas reclaim regulating valve assembly in accordance with the present invention.

FIG. 2 is a cross-section of the gas reclaim regulating valve shown as the diver is exhaling.

FIG. 3 is a cross-section of the gas reclaim regulating valve shown as the diver is inhaling.

FIG. 4 is a side elevated view of a switchblock in conjunction with the handle piece and the switchblock mounting plate.

FIG. 5 is a side elevated view of the handle piece.

FIG. 6 is a front view of the switchblock mounting plate.

FIG. 7 is a front elevated view of the switchblock mounting plate.

FIG. 8 is a cross-section view of the switchblock in conjunction with the handle piece and the switchblock mounting plate as seen from the side.

### DETAILED DESCRIPTION OF THE INVENTION

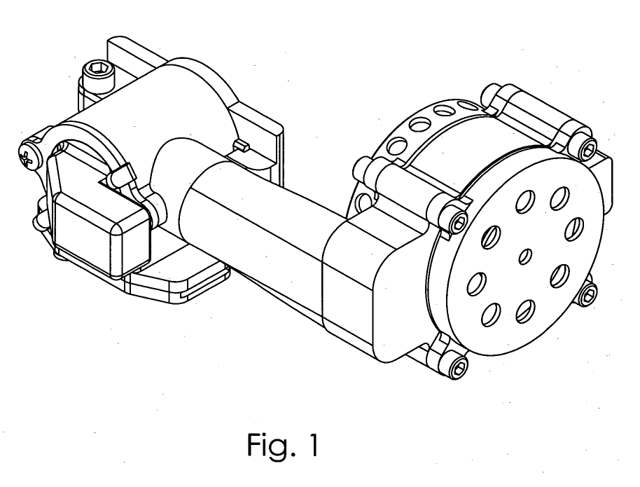

FIG. 1 shows an assembly of the gas reclaim regulating valve. Detailed views of the individual components are revealed in subsequent drawings.

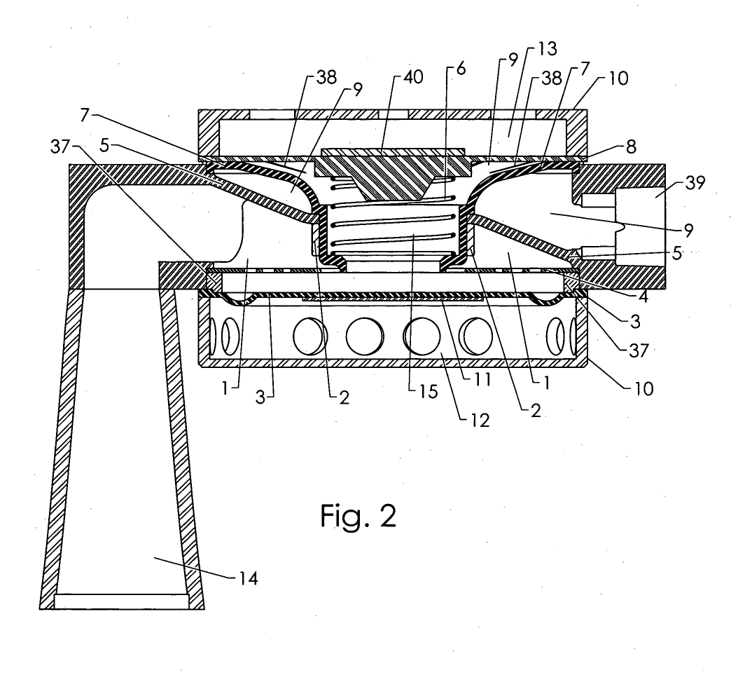

In FIG. 2, a cross-section of the gas reclaim regulating valve shown as the diver is exhaling, a first chamber (1) is defined between a first diaphragm (3) and a separator wall (5). A second chamber (9) is defined between the opposite side of the separator wall (5) and a second diaphragm (8). Inside the first chamber (1) is a second locking ring (37) that fits against the perimeter of the first chamber (1).

Inside the second chamber (9) is a slotted seat (7). The slotted seat (7) is funnel-shaped and extends from the first chamber (1) to the second chamber (9) creating a cylindrical-shaped tube (15). The slotted seat (7) has a convex surface configuration with which the second diaphragm (8) cooperates to cover a plurality of ports or openings (38) communicating with the second chamber (9). The ports (38) consist of an annular pattern of circular openings of different sizes of which the smaller are nearer the center of the slotted seat (7) so that in use the gas flow rate between the first chamber (1) and the second chamber (9) is proportional to the degree to which the second diaphragm (8) is lifted from the slotted seat (7). A spring (6) extends from the end of the slotted seat with the smallest diameter through the cylindrical-shaped tube (15) and through the second chamber (9) to the second diaphragm (8). The spring (6) provides a small amount of resistance against the second diaphragm allowing for a smaller cracking pressure on the second diaphragm (8) and therefore minimal WOB to lift the second diaphragm (8) off of the slotted seat (7) upon oscillation of pressure. A first locking ring (2) extends into the first chamber (1) and encompasses the outside perimeter of the portion of the slotted seat (7) that is disposed within the first chamber. The first locking ring (2) provides stability to the slotted seat (7) while the gas reclaim regulating valve is in use.

Located inside the first chamber (1) is a screen (4) which fits snugly between the second locking ring (37) and the end of the slotted seat (7) with the smallest diameter. The screen (4) is located within the first chamber (1) so as to keep any debris from entering the gas reclaim regulating valve and possibly causing malfunction. The second locking ring (37) also secures the first diaphragm (3) into place. On the opposite side of the first diaphragm (3) from the screen (4) is a first fixed metal disc (11), which is attached to the first diaphragm (3) to provide stability to the center of the first diaphragm (3) as well as providing a solid rigid surface to create an airtight seal. On the opposite side of the second diaphragm (8) from the slotted seat (7) is a second fixed metal disc (40) which is attached to the second diaphragm (8) to provide stability to the center of the second diaphragm (8) as well as a solid rigid surface to create an airtight seal.

The aforementioned parts fit snugly within a protective outer cup (10). A first enclosure (12) is formed between the outer cup (10), the first diaphragm (3), and the first fixed metal disc (11). A second enclosure (13) is formed between the outer cup (10), the second diaphragm (8), and the second fixed metal disc (40). Ambient water fills the first enclosure (12) and the second enclosure (13).

The first chamber (1) serves to receive the diver's exhaled gases directly through an inlet tube (14). A vacuum line port (39) located adjacent to the second chamber (9) allows the diver's exhaled gases to exit the gas reclaim regulating valve and return to the gas recovery unit on the surface above water.

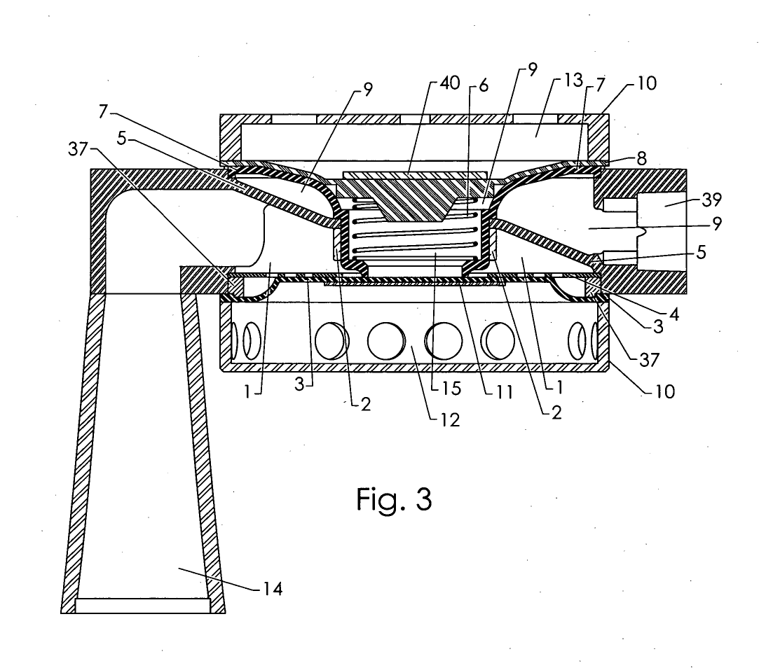

FIG. 3 is similar to FIG. 2 and reveals a cross-section of the gas reclaim regulating valve. In FIG. 3, however, the gas reclaim regulating valve is shown as the diver is inhaling. As such, a vacuum in the reclaim line created by a compressor in the recovery unit on the surface has forced the first diaphragm (3) and the second diaphragm (8) inward against the slotted seat (7). The second diaphragm (8) also compresses the spring (6). In this figure, the first diaphragm (3) is in communication with the portion of the slotted seat (7) with the smallest diameter and the screen (4) creating an airtight seal. The screen (4) does not interfere with the seal created between the first diaphragm and the slotted seat (7). The second diaphragm (8) is in communication with the slotted seat (7) such that the ports (38) are covered and an airtight seal is created.

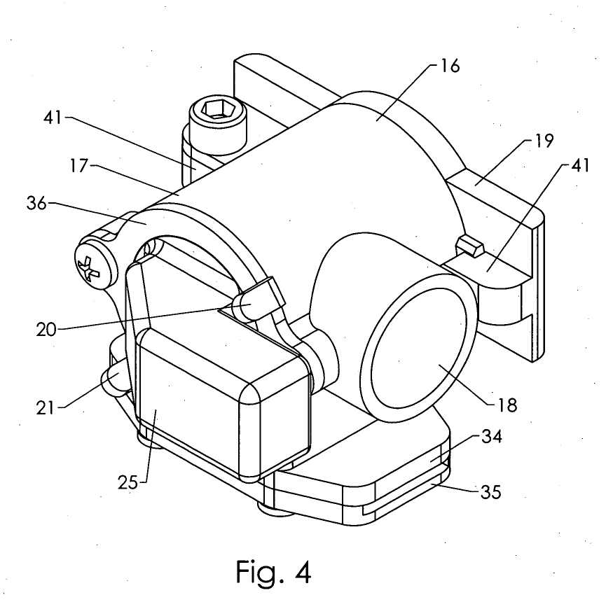

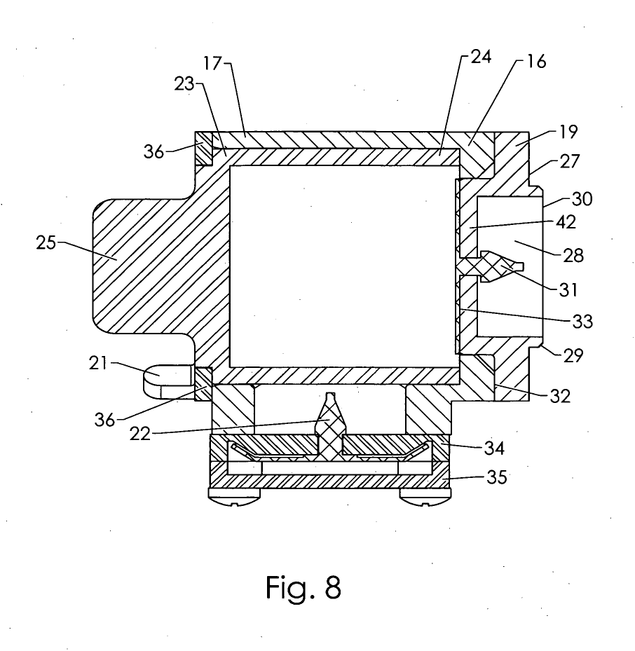

FIG. 4 reveals a switchblock comprising a first end (16) and a second end (17). The first end (16) of the switchblock attaches to a switchblock mounting plate (19) by way of cam locks (41) and a bolt. The cam locks (41) provide for easy removal of the gas reclaim regulating valve assembly from the diving helmet. However, when used in conjunction with the bolt, the cam locks (41) hold the gas reclaim regulating valve assembly securely to the helmet. A tube (18) extends perpendicularly from the side of the switchblock and attaches to the inlet tube (14) (see FIG. 2). A first flapper valve base (34) is attached to the switchblock between the first end (16) and the second end.(17). A first flapper valve (22) (see FIG. 8) is attached to the first flapper valve base (34). A flapper valve cover (35) attaches to the first flapper valve base (34). A handle (25) attaches to the second end (17) of the switchblock via a retaining ring (36). The handle (25) may only rotate clockwise or counterclockwise ninety degrees due to the first stopper (20) and the second stopper (21). When the handle (25) is in contact with the first stopper (20), as pictured, the circuit is closed and the diver's exhaled gases pass through the tube (18) to the inlet tube (14) (see FIG. 2) and into the gas reclaim regulating valve. When the handle (25) is in contact with the second stopper (21), the circuit is open and the diver's exhaled gases pass through the first flapper valve (22) (see FIG. 8) and out of the system.

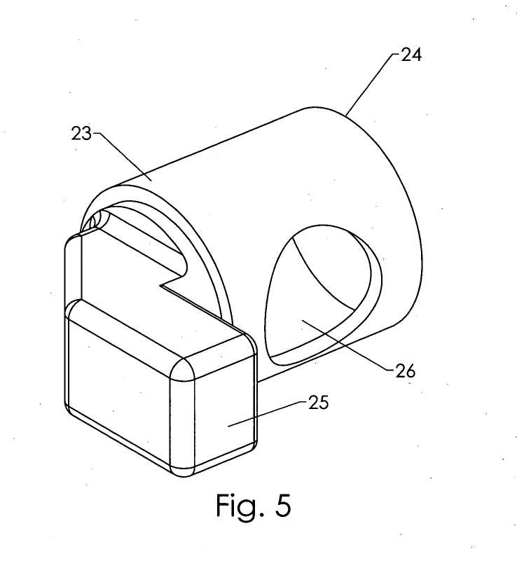

FIG. 5 shows the handle piece used to turn the circuit to the gas reclaim regulating valve on and off. The handle piece consists of a first end (23) and a second end (24). The handle piece fits inside the switchblock so that the first end (16) of the switchblock (seen FIG. 4) and the second end (24) of the handle piece correspond with one another. The second end (17) of the switchblock (see FIG. 4) and the first end (23) of the handle piece correspond. When the handle piece is fully inserted into the switchblock, the handle (25) remains outside of the switchblock and can be moved in a clockwise or counterclockwise manner to turn the circuit to the gas reclaim regulating valve on or off. This is accomplished via an opening (26) in between the first end (23) and the second end (24) of the handle piece. When the opening (26) corresponds to the tube (18) of the switchblock (see FIG. 4), the circuit is closed and the diver's exhaled gases may pass into the gas reclaim regulating valve. Similarly, when the opening (26) does not correspond to the tube (18) of the switchblock (see FIG. 4), the circuit is open and the diver's exhaled gases do not pass into the gas reclaim regulating valve. Instead the exhaled gases exit the system into the water via the first flapper valve (22) (see FIG. 8).

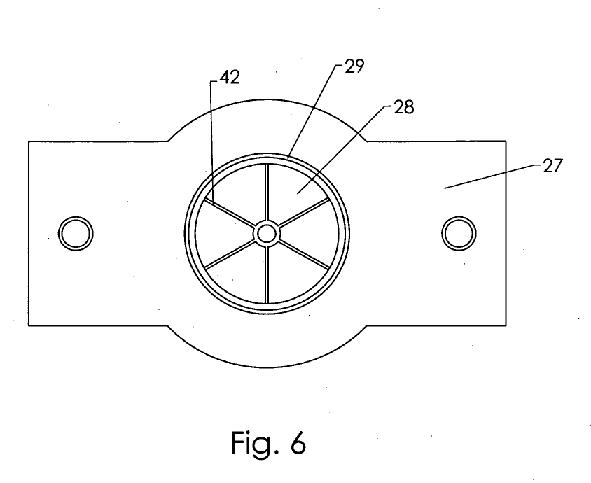

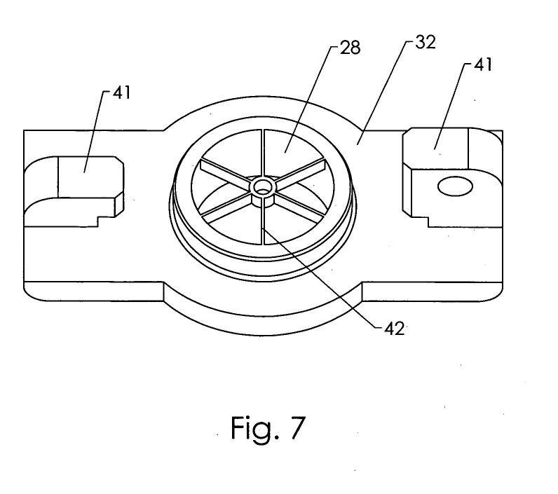

FIG. 6 reveals a front view of a switchblock mounting plate consisting of a first side (27) and a second side (32) (see FIG. 7). The first side (27) is seen in the figure; the second side (32) is not seen in this figure. The switchblock mounting plate is used in conjunction with the diver's helmet and the switchblock. The first side (27) of the switchblock mounting plate consists of a chamfered guide ring (29). In conjunction with the guide ring (29), the first side (27) of the switchblock mounting plate mounts against the diver's helmet. The second side (32) (seen in FIG. 7) of the switchblock mounting plate fits snugly against the switchblock with the assistance of cam locks (41) (see FIG. 7). A tube (28) connects the first side (27) and the second side (32) (see FIG. 7) of the switchblock mounting plate and allows the diver's exhaled gases to pass from the diver's underwater breathing apparatus to the switchblock. A second flapper valve base (42) is used to hold a second flapper valve (31) (see FIG. 8).

FIG. 7 reveals a front elevated view of the switchblock mounting plate. In this view of the switchblock mounting plate, the second side (32) is visible. The tube (28) that connects the first side (27) (see FIG. 6) and the second side (32) is seen as well as the second flapper valve base (42). Two cam locks (41) are used in conjunction with a bolt to attach the switchblock mounting plate to the switchblock (see FIG. 4). The cam locks (41) allow for easy removal of the gas reclaim regulating valve assembly.

FIG. 8 reveals a cross-sectional view of the switchblock in conjunction with the handle piece and the switchblock mounting plate. The handle piece is disposed within the switchblock such that the first end of the handle piece (23) corresponds to the second end of the switchblock (17). Similarly, the second end of the handle piece (24) corresponds to the first end of the switchblock (16). The switchblock mounting plate (19) is secured to the first end of the switchblock (16) such that the second side of the switchblock mounting plate (32) corresponds to the first end of the switchblock (16). The first side of the switchblock mounting plate (27) fits snugly against the diver's breathing apparatus with the assistance of a chamfered guide ring (29), cam locks (41), and a bolt. The tube (28) in the switchblock mounting plate consists of a first end (30) and a second end (33). Located at the second end of the tube (33) is a second flapper valve (31), a one-way valve that allows the diver's exhaled gases to be expelled from the underwater breathing apparatus but does not allow inhalation from the switchblock. Located adjacent to the second flapper valve (31) and disposed within the second end of the tube (33) is a second flapper valve base (42). As this figure is a cross-sectional view from the side, the starburst-like appearance of the second flapper valve base (42) (as seen in FIGS. 6 and 7) is not visible. Located between the first end (16) and the second end (17) of the switchblock is the first flapper valve (22), which may be engaged when it corresponds with the opening of the handle piece (see FIG. 5). This occurs when the handle (25) is in such a position that the circuit is open; resulting in the diver's exhaled gases exiting the system through the first flapper valve (22). Such a scenario is desired in the case of malfunction or emergency. The first flapper valve (22) fits snugly into the first flapper valve base (34) and held securely into place by a flapper valve cover (35). The handle (25) extends outwards from the switchblock. The retaining ring (36) is used to secure the handle piece into the switchblock. The handle (25) may only rotate clockwise or counterclockwise ninety degrees due to the first stopper (20) and the second stopper (21). When the handle (25) is in contact with the first stopper (20) (see FIG. 4), the circuit is closed and the diver's exhaled gases pass through the tube (18) (see FIG. 4) to the inlet tube (14) (see FIG. 2) and into the gas reclaim regulating valve. When the handle (25) is in contact with the second stopper (21), the circuit is open and the diver's exhaled gases pass through the first flapper valve (22) and out of the system.

Operation of the gas reclaim regulating valve assembly is as follows. A vacuum exists inside the gas reclaim regulating valve due to the combined effect of water pressure and a compressor in the recovery unit on the surface above water. The compressor of the recovery unit lowers the pressure in the hose that extends from the vacuum line port (39) of the valve to the surface. As the diver inhales, the first diaphragm (3) and the second diaphragm (8) are compressed towards each other. The spring (6) located between the two diaphragms is compressed as well. Fixed metal discs (11 and 40) are attached to both of the diaphragms to provide additional strength and stability to the diaphragms as they are flexed towards each other. FIG. 3 illustrates this stage of the operation of the gas reclaim regulating valve assembly.

As the diver begins exhaling, air moves into the switchblock. If the circuit is closed, the gas moves through the inlet tube (14) and into the first chamber (1). This change in pressure forces the first diaphragm (3) to move to a flat position allowing gas to pass through the cylindrical shaped tube (15) towards the second diaphragm (8). The pressure of the exhaled gases lifts the second diaphragm (8) off of its position against the slotted seat (7). As the second diaphragm (8) lifts off of the slotted seat (7), gas travels through the ports (38) of the slotted seat (7) and into second chamber (9). The gas then moves out of the vacuum line port (39) and through tubing of the reclaim line up to the surface where the gas can be recovered. FIG. 2 illustrates this stage of the operation of the gas reclaim regulating valve assembly. As the diver then begins inhaling again, the first diaphragm (3) and second diaphragm (8) compress towards each other and a vacuum is created due to the combined effect of water pressure in the first enclosure (12) and second enclosure (13) and the compressor in the recovery unit on the surface.

If the circuit is open when the diver begins exhaling, gas moves into the switchblock and exits out of the first flapper valve (22) located underneath the switchblock. The gases are released in the form of gas bubbles into the water. The gas bubbles escape out of opposite ends of the first flapper valve base (34) and flapper valve cover (35). The first flapper valve base (34) and flapper valve cover (35) are elongated so as separate the two streams of gas bubbles so that the bubbles do not impede the vision of the diver.

In the case of malfunction or emergency, the diver need use only one hand to turn the handle piece inside of the switchblock to open the circuit.

What is claimed is:

1. A gas reclaim regulating valve assembly comprising a composite housing having an inlet tube to receive a diver's exhaled gases and a vacuum line port for connection to a reclaim line, said composite housing having:
a. A first chamber defined, in part, by a first diaphragm and a separator wall, said first chamber being in gaseous communication with said inlet tube, a first portion of said housing overlying said first diaphragm being provided with means defining and opening for permitting ambient water access to an outside surface of said first diaphragm;
b. A second chamber defined, in part, by a second diaphragm and said separator wall, said second chamber being in gaseous communication with said vacuum line port, a second portion of said housing overlying said second diaphragm being provided with means defining and opening for permitting ambient water access to an outside surface of said second diaphragm;
c. A slotted seat disposed in said second chamber between said second diaphragm and said separator wall, said slotted seat comprising a plurality of ports spaced around the circumference of said slotted seat, each port extending radially and being proportioned with an inner portion which narrows to a tip of minimal radius dimension; and
d. A cylindrical shaped tube defined, in part, by a portion of said slotted seat disposed between said first chamber and said second chamber for permitting gaseous communication therebetween, said cylindrical shaped tube having a first end disposed within said first chamber and a second end disposed in said second chamber.

2. A gas reclaim regulating valve assembly according to claim 1, further comprising a spring disposed within said cylindrical shaped tube such that said spring is in communication with said first end of the cylindrical shaped tube and said second diaphragm.

3. A gas reclaim regulating valve assembly according to claim 1, further comprising a screen disposed within said first chamber such that the diver's exhaled gases flow through said screen.

4. A gas reclaim regulating valve assembly according to claim 1, further comprising a switchblock comprising a first end and a second end, and further comprising a tube disposed between said first end and said second end such that said tube is in communication with said inlet tube.

5. A gas reclaim regulating valve assembly according to claim 4, further comprising a handle piece disposed in said switchblock that comprises an opening in said handle piece such that said opening may correspond to said tube on said switchblock for allowing gaseous communication between said switchblock and said inlet tube.

6. A gas reclaim regulating valve assembly according to claim 4, further comprising a first one-way valve such that the diver's exhaled gases may pass out of said switchblock and out of the gas reclaim regulating valve assembly.

7. A gas reclaim regulating valve assembly according to claim 1, further comprising a switchblock mounting plate comprising means of attaching said switchblock to the diver's helmet.

8. A gas reclaim regulating valve assembly according to claim 7, further comprising a second one-way valve such that the diver's exhaled gases may pass out of the diver's helmet.

9. A gas reclaim regulating valve assembly comprising:
a. A composite housing having said inlet tube to receive a diver's exhaled gases and said vacuum line port for connection to a reclaim line, said composite housing having a first chamber defined, in part, by a first diaphragm and a separator wall, said first chamber being in gaseous communication with said inlet tube, a first portion of said housing overlying said first diaphragm being provided with means defining and opening for permitting ambient water access to an outside surface of said first diaphragm, and a second chamber defined, in part, by a second diaphragm and said separator wall, said second chamber being in gaseous communication with said vacuum line port, a second portion of said housing overlying said second diaphragm being provided with means defining and opening for permitting ambient water access to an outside surface of said second diaphragm;
b. A slotted seat disposed in said second chamber between said second diaphragm and said separator wall, said slotted seat comprising a plurality of ports spaced around the circumference of said slotted seat, each port extending radially and being proportioned with an inner portion which narrows to a tip of minimal radius dimension;
c. A cylindrical shaped tube defined, in part, by a portion of said slotted seat disposed between said first chamber and said second chamber for permitting gaseous communication therebetween, said cylindrical shaped tube having a first end disposed within said first chamber and a second end disposed in said second chamber;
d. A spring disposed within said cylindrical shaped tube such that said spring is in communication with said first end of the cylindrical shaped tube and said second diaphragm;
e. A screen disposed within said first chamber such that the diver's exhaled gases flow through said screen;
f. A switchblock comprising a first end and a second end, and further comprising said tube disposed between said first end and said second end such that said tube is in communication with said inlet tube;
g. A handle piece is disposed in said switchblock and comprises an opening in said handle piece such that said opening may correspond to said tube on said switchblock for allowing gaseous communication between said switchblock and said inlet tube;
h. A first one-way valve such that the diver's exhaled gases may pass out of said switchblock and out of the gas reclaim regulating valve assembly;
i. A switchblock mounting plate comprising means of attaching the switchblock to the diver's helmet;
j. A second one-way valve such that the diver's exhaled gases may pass out of the diver's helmet; and
k. A first stage valve comprising said first diaphragm and said first chamber and a second stage valve comprising said second diaphragm and said second chamber, the arrangement being such that, in use, said housing is secured to said inlet tube which is connected to said switchblock which is secured to said switchblock mounting plate which is secured to the diver's helmet, and said vacuum line port is connected to a gas reclaim line, and in the absence of exhalation, the ambient pressure of seawater acts in said first diaphragm and said second diaphragm to close the first stage valve and the second stage valve isolating the diver from the negative pressure in the gas reclaim line and said second diaphragm covers said vacuum line port, and when the diver exhales, the first diaphragm is separated from said cylindrical shaped tube and the second diaphragm is separated from said slotted seat against ambient seawater pressure to open said first stage valve and said second stage valve, so that the exhalation gases are conducted in sequence from the diver's helmet through said switchblock mounting plate through said switchblock through said inlet tube through said first chamber through said second chamber, and through said vacuum line port to the gas reclaim line.
